(19) United States
(12) Patent Application Publication
(10) Pub. No.: US 2004/0038824 A1
(43) Pub. Date: Feb. 26, 2004

(54) Agrochemical composition

(76) Inventors: Hans Walter Haesslin, Muenchwilen (DE); Fritz Blatter, Basel (CH)

Correspondence Address: SYNGENTA CROP PROTECTION , INC., PATENT AND TRADEMARK DEPARTMENT, 410 SWING ROAD, GREENSBORO, NC, 27409, US

(21) Appl. No.: 10/415,565

(22) PCT Filed: Oct. 29, 2001
(86) PCT No.: PCT/EP01/12482

(30) Foreign Application Priority Data
Nov. 1, 2000 (CH) 2135/00

(51) Int. Cl. A01N 25/32

(52) U.S. Cl. 504/105

(57) ABSTRACT

Agrochemical composition in the form of a suspension concentrate, comprising, in addition to further customary formulation auxiliaries, a surface-active compound and a quinoline safener of the formula (I) in which n is 2 to 6.

The present invention relates to novel agrochemical compositions in the form of concentrates comprising a quinoline safener.

Quinolines, their preparation and their action as safeners are known from a series of publications such as DE-A-2546845, U.S. Pat. No. 3,351,525, Chem. Abstr. 79 (1973) 53154r and EP-A-94349.

The present invention relates to agrochemical compositions in the form of suspension concentrates comprising, in addition to further customary formulation auxiliaries, a surface-active compound and a quinoline safener, wherein the quinoline safener is one of the formula I

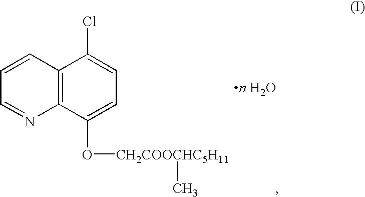

in which n is 2 to 6, preferably 4 to 5 and in particular 4.

The compositions according to the invention have the advantage that the compound of the formula I proves to be stable in water under hydrate form, in contrast to the nonhydrated form. The specific form in which the safener is present in aqueous suspension makes it possible to prepare stable mixtures with other safeners and/or herbicides which would otherwise, for example in solution, be incompatible.

The safener of the formula I can be prepared in a simple manner, for example by stirring the nonhydrated form which is known from EP-A-94349 (1-methylhexyl (5-chloroquinolin-8-yloxy)acetate) in water, if appropriate in the presence of a surface-active compound, preferably at room temperature.

The safener of the formula I is novel and also a subject of the present invention. The safener of the formula I is preferably characterized by the powder x-ray reflexes shown in Table 1. Lower water contents may suggest, for example, a mixture of a hydrate, for example with tetrahydrate, and, for example, the nonhydrated form of 1-methylhexyl (5-chloroquinolin-8-yloxy)acetate.

The compositions according to the invention may additionally comprise a herbicide. This is preferably a representative selected from the group of the sulphonyl ureas, sulphonamides, imidazolinones, carbazones, cyclohexanediones, arylcarboxylic acids, aryloxycarboxylic acids and, in particular, aryloxyphenoxypropionates.

Herbicides to be mentioned which are particularly suitable for combination with the safener of the formula I are, in particular, sulphonylureas, preferably triasulfuron, tribenuron, metasulfuron, thifensulfuron, flupyrsulfuron, iodosulfuron, rimsulfuron, nicosulfuron, cinosulfuron, bensulfuron, trifloxysulfuron and analogs, furthermore sulphonarnides, preferably flumetsulam, metosulam, chloransulam, floransulam and analogs, and imidazolinones, preferably imazethabenz, imazethapyr, imazaquin, imazamox and analogs, then carbazones, preferably flucarbazone, propoxycarbazine, amicarbazone and analogs, furthermore aryloxyphenoxypropionates, preferably clodinafop, fenoxaprop, diclofop, propaquizafop, quizalofop, fluazifop, cyhalofop, haloxyfop and analogs, and also cyclohexanediones, preferably sethoxydim, clethodim, tralkoxydim and analogs, oxopyrazolin derivatives as are known, for example, from WO 99/47525, and arylcarboxylic acids, preferably dicamba and clopyralid, and aryloxycarboxylic acids, preferably 2,4-D, mecoprop, fluroxypyr and analogs, furthermore amicarbazone, azafenidin, benfluamid, benzfendizone, benzobicyclon, cinidon-ethyl, diclosulam, fentrazamid, flufenacet, flufenpyr, foramsulphuron, indanofan, mesosulphuron, oxaziclomefone, penoxsulam, pethoxamid, picolinafen, profoxidim, profluazol, propoxycarbazone, pyraflufen, pyrazogyl, sulphosulphuron, tepraloxydim and tritosulphuron.

For application, the safener of the formula I, if appropriate together with a herbicide, is expediently processed together with the surface-active compound and the further auxiliaries conventionally used in the art of formulation to give agrochemical compositions in the form of suspension concentrates (EC, SC). The compositions according to the invention are prepared in the known manner, for example by intimately mixing and/or grinding the active ingredients in the presence of water, in the presence of the surface-active compound.

Suitable surface-active compounds are nonionic, cationic and/or anionic surfactants and surfactant mixs with good emulsifying, dispersing and wetting properties.

Suitable anionic surfactants may be what are known as water-soluble soaps or else watersoluble synthetic surface-active compounds.

Soaps which may be mentioned are the alkali metal salts, alkaline earth metal salts or substituted and unsubstituted ammonium salts of higher fatty acids (C₁₀-C₂₂), such as, for example, the sodium or potassium salts of oleic or stearic acid, or of natural fatty acid mixtures which may be obtained from, for example, coconut oil or tallow oil. The fatty acid methyltaurides may also be mentioned.

However, surfactants which are used more frequently are what are known as synthetic surfactants, in particular fatty alcohol sulphonates, fatty alcohol sulphates, sulphonated benzimidazol derivatives or alkylarylsulphonates.

The fatty alcohol sulphonates or fatty alcohol sulphates are generally present in the form of alkali metal salts, alkaline earth metal salts or substituted and unsubstituted ammonium salts and have an alkyl radical of 8 to 22 carbon atoms, alkyl also including the alkyl moiety of acyl radicals, for example the sodium or calcium salt of lignosulphonic acid, of the dodecylsulphuric ester or of a fatty alcohol sulphate mixture prepared from natural fatty acids. The group also includes the salts of the sulphuric esters and sulphonic acids of fatty alcohol/ethylene oxide adducts. The sulphonated benzimidazole derivatives preferably comprise 2 sulpho groups and one fatty acid radical of 8-22 carbon atoms. Examples of alkylarylsulphonates are the sodium salts, calcium salts or triethanolamine salts of the dodecylbenzenesulphonic acid, of dibutylnaphthalenesulphonic acid, or of a naphthalenesulphonic acid/formaldehyde condensate.

Suitable phosphates such as, for example, salts of the phosphoric ester of a pnonylphenol/(4-14) ethylene oxide adduct, or phospholipids, are furthermore also suitable.

Suitable nonionic surfactants are, mainly, polyglycol ether derivatives of aliphatic or cycloaliphatic alcohols, saturated or unsaturated fatty acids and alkylphenols which may comprise 3 to 30 glycol ether groups and 8 to 20 carbon atoms in the (aliphatic) hydrocarbon radical and 6 to 18 carbon atoms in the alkyl radical of the alkyl phenols.

Further suitable nonionic surfactants are the water-soluble polyethylene oxide adducts with polypropylene glycol, ethylenediaminopolypropylene glycol and alkyl polypropylene glycol having 1 to 10 carbon atoms in the alkyl chain which comprise 20 to 250 ethylene glycol ether groups and 10 to 100 propylene glycol ether groups. Usually, the abovementioned compounds comprise 1 to 5 ethylene glycol units per propylene glycol unit.

Examples of nonionic surfactants which may be mentioned are nonylphenol polyethoxyethanols, castor oil polyglycol ether, polypropylene/polyethylene oxide adducts, tributylphenoxypolyethoxyethanol, polyethylene glycol and octylphenoxypolyethoxyethanol.

Fatty acid esters of polyoxyethylene sorbitan, such as polyoxyethylene sorbitan trioleate, are furthermore also suitable.

The cationic surfactants are, mainly, quarternary ammonium salts which have at least one alkyl radical of 8 to 22 carbon atoms as N-substituents and, as further substituents, lower, unhalogenated or halogenated, alkyl, benzyl or lower hydroxyalkyl radicals. The salts are preferably in the form of halides, methylsulphates or ethylsulphates, for example stearyltrimethylammonium chloride or benzyldi(2-chloroethyl)ethylammonium bromide.

Surface-active compounds which can be employed as being especially suitable for the compositions according to the invention are partially alkylated, in particular butylated or hexadecylated, polyvinylpyrrolidones (for example AGRIMER AL 10®, AGRIMER AL 25®), polyacrylates with PO side chains (for example ATLOX 4913°), sulphonated naphthalene/formaldehyde condensates (for example OROTAN SN®, MORWET D 425), ethoxylated polyarylphenol sulphates (for example SOPROPHOR 4D384®), diglycol cyclohexyldimethanol isophthalate sulphoisophthalate mixed polyesters (for example ULTRAPOLYMER AQ 48®), unmodified or polyether-modified polyacrylates with basic adhesive groups (for example DiSPERBYK 191®), surface-active linear polyesters (for example DISPERBYL 192®), di- and tristyrylphenol ethoxylates, di- and tristyrylphenol phosphates, di- and tristyrylphenol sulphates, and mixtures of the abovementioned surfaceactive compounds.

Surfactants conventionally used in the art of formulation which may also be used in the compositions according to the invention are described, inter alia, in “McCutcheon's Detergents and Emulsifiers Annual” MC Publishing Corp., Ridgewood N.J., 1981, Stache, H., “Tensid-Taschenbuch [Surfactants Guide]”, Carl Hanser Verlag, Munich/Vienna, 1981, and M. and J. Ash, “Encyclopedia of Surfactants”, Vol I-III, Chemical Publishing Co., New York, 1980-81.

As a rule, the compositions according to the invention comprise 0.1 to 99% by weight, in particular 0.1 to 95% by weight, of safener of the formula I, with or without the herbicide, 1 to 99.9% by weight of a solid or liquid formulation auxiliary and 0 to 25% by weight, in particular 0.1 to 25% by weight, of the surface-active compound.

The compositions may also comprise further additives such as stabilizers, for example epoxidized or unepoxidized vegetable oils (epoxidized coconut oil, rapeseed oil or soya oil), antifoams, for example silicone oil, preservatives, viscosity regulators, binders, adhesives and fertilizers or other active ingredients.

The invention also relates to a method of selectively controlling weeds in crops of useful plants, which consist in treating the useful plants, their seeds or slips or their area of cultivation simultaneously or separately with a herbicidally effective amount of the herbicide and a herbicide-antagonistically effective amount of the safener of the formula I.

Areas of cultivation refer to the areas of ground which already sustain the crop plants or which have been sown with the seed of these crop plants, and also the soils on which these crop plants are intended to grow.

Suitable crop plants which can be protected by the safener of the formula I against the damaging effect of the abovementioned herbicides are, in particular, cereals, maize, sorghum and millet species, rice, and also sugar cane, useful grasses and ornamental grasses, and also soybeans, cotton, sugarbeet and other broad-leaved crops. Crops are also to be understood as including those which have been made tolerant to herbicides or classes of herbicides by conventional breeding methods or by recombinant methods.

The weeds to be controlled can take the form of monocotyledonous and dicotyledonous weeds such as, for example, Stellaria, Nasturtium, Agrostis, Digitaria, Avena, Setaria, Sinapis, Lolium, Solanum, Phaseolus, Echinochloa, Scirpus, Monochoria, Sagittaria, Bromus, Poa, Phalaris, Alopecurus, Sorghum halepense, Rottboellia, Cyperus, Abutilon, Sida, Xanthium, Amaranthus, Chenopodium, lpomoea, Chrysanthemum, Galium, Viola, Lamium, Veronica and Cynodon.

Depending on the intended use, the safener of the formula I can be employed for pretreating the seed of the crop plant (addressing of the seed or the slips) or incorporated into the soil before or after sowing. However, it may also be applied alone or together with the herbicide after emergence of the plants. The treatment of the plants or of the seed with the safener can therefore, in principle, be effected independently of the point in time of application of the herbicide. However, the plants can also be treated by applying herbicide and safener simultaneously (for example as a tank mix). In accordance with the invention, safener and herbicide may be present in separate concentrates, for example the safener in a suspension concentrate and the herbicide in an emulsifiable concentrate, or else in a single suspension concentrate.

Prior to use, the concentrates are combined with customary diluents such as, for example, water, oils or liquid fertilizers, or mixtures of these. In addition, adjuvants may also be used, such as, for example, nonionic surfactants, mixtures of nonionic surfactants, mixtures of anionic surfactants with nonionic surfactants, cationic surfactants, organosilicon surfactants, mineral oil derivatives with or without surfactants, vegetable oil derivatives with or without added surfactants, alkylated derivatives of oils of vegetable or mineral origin with or without surfactants, fish oils and other oils of animal origin and their alkyl derivatives with or without surfactants, naturally occurring higher fatty acids, preferably those having 8 to 28 carbon atoms and their alkyl ester derivatives, organic acids comprising an aromatic ring system and one or more carboxyl radicals and their alkyl derivatives, furthermore suspensions of polymers of vinylacetate or copolymers of vinyl acetate/acrylic esters. Mixtures of individual adjuvants with each other and in combination with organic solvents may lead to a further increase in action. Suitable examples of nonionic surfactants are polyglycol ether derivatives of aliphatic or cycloaliphatic alcohols, of saturated and unsaturated fatty acids and alkylphenols, which can preferably comprise 3 to 30 glycol ether groups and 8 to 20 carbon atoms in the (aliphatic) hydrocarbon radical and 6 to 18 carbon atoms in the alkyl radical of the alkylphenol. Further nonionic surfactants which are suitable are the water-soluble polyethylene oxide adducts with polypropylene glycol, ethylenediaminopolypropylene glycol and alkyl polypropylene glycol with preferably 1 to 10 carbon atoms in the alkyl chain, which preferably comprise 20 to 250 ethylene glycol ether groups and 10 to 100 propylene glycol ether groups. Usually, the abovementioned compounds comprise 1 to 5 ethylene glycol units per propylene glycol unit. Further examples of nonionic surfactants which may also be mentioned are nonylphenolpolyethoxyethanols, castor oil polyglycol ethers, polypropylene/polyethylene oxide adducts, tributylphenoxypolyethoxyethanol, polyethylene glycol and octylphenoxypolyethoxyethanol. Fatty acid esters of polyoxyethylene sorbitan, such as polyoxyethylene sorbitan trioleate, are also suitable. Preferred among the anionic surfactants are, mainly, alkyl sulphates, alkylsulphonates, alkylarylsulphonates, alkylated phosphoric acids, and their ethoxylated derivatives. The alkyl radicals usually comprise 8 to 24 carbon atoms. Preferred nonionic surfactants are known under the following trade names: polyoxyethylene cocoalkylamine (for example AMIET® 105 (Kao Co.)), polyoxyethylene oleylamine (for example AMIET® 415 (Kao Co.)), nonylphenolpolyethoxyethanols, polyoxyethylene stearylamine (for example AMIET® 320 (Kao Co.)), N-polyethoxyethylamines (for example GENAMIN® (Hoechst AG)), N,N,N′,N′-tetra(polyethoxypolypropoxyethyl)ethylenediamines (for example TERRONIL® and TETRONIC® (BASF Wyandotte Corp.)), BRIJ®D (Atlas Chemicals), ETHYLAN® CD and ETHYLAN® D (Diamond Shamrock), GENAPOL®D C, GENAPOL® 0, GENAPOL®) S and GENAPOL® X080 (Hoechst AG), EMULGEN® 104P, EMULGEN® 109P and EMULGEN® 408 (Kao Co.); DISTY® 125 (Geronazzo), SOPROPHOR® CY 18 (Rhône Poulenc S.A.); NONISOL® (Ciba-Geigy), MRYJ® (ICI); TWEEN® (ICI); EMULSOGEN® (Hoechst AG); AMIDOX®D (Stephan Chemical Co.), ETHOMID® (Armak Co.); PLURONIC® (BASF Wyandotte Corp.), SOPROPHOR® 461 P (Rhône Poulenc S.A.), SOPROPHOR® 496/P (Rhône Poulenc S.A.), ANTAROX FM-63 (Rhone Poulenc S.A.), SLYGARD 309 (Dow Corning), SILWET 408, SILWET L-7607N (Osi-Specialities). The cationic surfactants are, mainly, quaternary ammonium salts which comprise at least one alkyl radical of 8 to 22 carbon atoms as N-substituents and, as further substituents, lower, halogenated or unhalogenated alkyl, benzyl or lower hydroxyalkyl radicals. The salts are preferably in the form of halides, methylsulphates or ethylsulphates, for example stearyltrimethylammonium chloride or benzyldi(2-chloroethyl)ethylammonium bromide. The oils used are either of mineral or natural origin. In addition, the natural oils may be of animal or vegetable origin. Preferred among the animal oils are, mainly, beef tallow derivatives, but fish oils (for example sardine oil) and their derivatives are also used. Vegetable oils are in most cases seed oils of various origins. Examples which may be mentioned of vegetable oils used in particular are coconut oils, rapeseed oils or sunflower oils and their derivatives. Surfactants, oils, in particular vegetable oils, their derivatives such as alkylated fatty acids and their mixtures, for example with, preferably, anionic surfactants such as alkylated phosphoric acids, alkyl sulphates and alkylarylsulphonates and higher fatty acids, which are conventionally used in the art of the formulations and adjuvants and which may also be used in the compositions according to the invention and their spray mixtures are described, inter alia, in “McCutcheon's Detergents and Emulsifiers Annual” MC Publishing Corp., Ridgewood N.J., 1998, Stache, H., “Tensid-Taschenbuch [Surfactants Guide]”, Carl Hanser Verlag, Munich/Vienna, 1990, M. and J. Ash, “Encyclopedia of Surfactants”, Vol I-IV, Chemical Publishing Co., New York, 1981-89, G. Kapusta, “A Compendium of Herbicide Adjuvants”, Southern Illinois Univ., 1998, L. Thomson Harvey, “A Guide to Agricultural Spray Adjuvants Used in the United States”, Thomson Pubns., 1992. Preferred adjuvants are commercially available under the names Merge, Score, Actipron, Amigo, Emery, Edenor, Partna and Hasten.

The application rate of safener relative to herbicide which is to be applied depends largely on the type of application. In the case of field treatment, which is effected either using a tank mix with a combination of safener and herbicide or by a separate application of safener and herbicide, the herbicide:safener ratio is, as a rule, 1:100 to 1:1, preferably 1:50 to 5:1.

As a rule, 0.001 to 5.0 kg, preferably 0.001 to 0.5 g, of safener are applied per hectare in the case of the field treatment.

The application rate of a herbicide is, as a rule, between 0.001 and 2 kg/ha, but preferably between 0.005 and 1 kg/ha.

The compositions according to the invention are suitable for all application methods conventionally used in agriculture such as, for example, pre-emergence application, post-emergence application and seed dressing.

A variety of methods and techniques such as, for example, those given hereinbelow are suitable for use in the safener of the formula I or compositions comprising it for protecting crop plants against damaging effects of herbicides:

i) Seed Dressing

a) The seeds are dressed with the safener formulated as suspension concentrate by shaking in a vessel until the seed surface is covered uniformly (dry seed dressing). Approximately 1 to 500 g of safener (4 g to 2 kg of wettable powder) are used per 100 kg of seeds.

b) Seed dressing by immersing the seed into a liquor with 100-1000 ppm of safener of the formula I, preferably for 1 to 72 hours, if appropriate followed by drying the seeds (immersion dressing). If appropriate, briefly dipping the seed may also suffice.

Naturally, dressing the seed or treating the seedling which has started to germinate are the preferred methods of application since the safener treatment is directed entirely at the target crop. As a rule, 1 to 1000 g of safener, preferably 5 to 250 g of safener, are used per 100 kg of seed, it being possible to deviate from the limit concentrations stated in either direction, depending on the methodology, which also makes possible the addition of other active ingredients or micronutrients (a repeated seed dressing).

ii) Application as Tank Mix

A liquid preparation of a mixture of safener and herbicide (mutual quantitative ratio between 5:1 and 1:100) is used, the application rate of herbicide amounting to 0.001 to 2.0 kg per hectare. Such tank mixes are applied before or after sowing.

iii) Application into the Seed Farrow

The safener is introduced into the open seed farrow into which seed has been sown in the form of a suspension concentrate in concentrated or diluted form. After the seed farrow has been covered up, the herbicide is applied pre-emergence in the usual manner.

The compositions according to the invention preferably comprise:

| | |
|---|---|
| Active ingredient mixture: | 3 to 75%, preferably 10 to 50% |
| Water: | 94 to 24%, preferably 88 to 30% |
| Surface-active compound: | 1 to 40%, preferably 2 to 30% |

(Active ingredient mixture = safener +
herbicide; % = per cent by weight)

Especially preferred compositions comprise:

| | a) | b) | c) | d) | e) |
|---|---|---|---|---|---|
| Active ingredient mixture | 3% | 10% | 25% | 50% | 50% |
| Ethylene glycol | 5% | 5% | 5% | 5% | — |
| Nonylphenol polyglycol ether | — | 1% | 2% | — | — |
| (15 moles of EO) | | | | | |
| Polymeric surface-active compound | 0.1% | 0.5% | 1% | 2% | 2% |
| Sodium lignosulphonate | 3% | 3% | 4% | 5% | 5% |
| Xanthan gum | 0.2% | 0.2% | 0.2% | 0.2% | 0.2% |
| 37% aqueous formaldehyde solution | 0.2% | 0.2% | 0.2% | 0.2% | 0.2% |
| Silicone oil emulsion | 0.8% | 0.8% | 0.8% | 0.8% | 0.8% |
| Water | 87% | 79% | 62% | 38% | 38% |

(Active ingredient mixture = safener + herbicide; % = per cent by weight)
Compositions a), b) and c) may also be free from ethylene glycol.

Polymeric surface-active compounds which may be suitable in the above examples are: partially alkylated, in particular butylated or hexadecylated, polyvinylpyrrolidones (for example AGRIMER AL 10®, AGRIMER AL 25®), polyacrylates with EO side chains (for example ATLOX 4913®), sulphonated naphthalene/formaldehyde condensates (for example OROTAN SN®, MORWET D 425®), ethoxylated polyarylphenol sulphates (for example SOPROPHOR 4D384(D), diglycol cyclohexyldimethanol isophthalate sulphoisophthalate mixed polyesters (for example ULTRAPOLYMER AQ 48®), polyacrylates with basic adhesive groups, unmodified and polyether-modified (for example DiSPERBYK 191®) and surface-active linear polyesters (for example DISPERBYL 192®), and mixtures of these.

Frequently, it is practical to formulate the active ingredient of the formula I and the herbicide individually and then to combine them in the water in the applicator in the desired mixing ratio shortly before application, for example as a “tank mix”.

The preparation and the ability of the safener of the formula I as protecting crop plants against the phytotoxic effect of herbicides is illustrated in the examples which follow.

### EXAMPLE 1

500 mg of 1-methylhexyl (5-chloroquinolin-8-yloxy)acetate which has been purified to 99.0% are suspended in water and the suspension is stirred for 48 hours at room temperature. Thereupon, the suspension is filtered and the product obtained, 1-methylhexyl (5-chloroquinolin-8-yloxy)acetate tetrahydrate, is examined by means of powder x-ray diffractometry while moist. The powder x-ray diffraction at 90% atmospheric humidity reveals an x-ray diagram with the reflexes shown in Table 1.

TABLE 1
Powder x-ray reflexes (2θ° and d values) and
approximate relative intensities

| | | approximate relative |
|---|---|---|
| Value 2θ[°] | d values [10⁻¹⁰m] | intensity in % |
| 4.3 | 20.5 | 50 |
| 7.4 | 11.9 | 100 |
| 8.6 | 10.3 | 40 |
| 11.3 | 7.8 | 17 |
| 12.8 | 6.9 | 33 |
| 14.8 | 5.97 | 3 |
| 15.4 | 5.74 | 10 |
| 18.7 | 4.75 | 4 |
| 19.6 | 4.52 | 7 |
| 21.4 | 4.14 | 13 |
| 22.3 | 3.98 | 20 |
| 22.7 | 3.91 | 13 |
| 23.9 | 3.72 | 30 |
| 26.2 | 3.40 | 3 |
| 30.2 | 2.96 | 3 |
| 31.1 | 2.87 | 3 |
| 34.7 | 2.59 | 3 |

### EXAMPLE 2

500 mg of purified 1-methylhexyl (5-chloroquinolin-8-yloxy)acetate are suspended in 5.0 ml of aqueous surfactant solution comprising 1% Mowiol 1888® and the suspension is stirred at room temperature. After the suspension has been stirred for approximately 16 hours, it is filtered off and the moist cake on the filter is rinsed with approximately 10-20 ml of water. The powder x-ray diffraction of the resulting product at 90% atmospheric humidity reveals an x-ray diagram with reflexes as shown in Table 1.

### EXAMPLE 3

500 mg of 1-methylhexyl (5-chloroquinolin-8-yloxy)acetate are dissolved in 2.0 ml of acetonitrile. 5.0 ml of water are pipetted stepwise at room temperature into this solution. The precipitate which has formed is filtered off and the product obtained is examined by powder x-ray diffractometry under humidity-controlled conditions. The powder x-ray diffraction at 90% atmospheric humidity reveals an x-ray diagram with reflexes as shown in Table 1.

### EXAMPLE 4

500 mg of 1-methylhexyl (5-chloroquinolin-8-yloxy)acetate are dissolved in 2.0 ml of isopropanol at room temperature. Then, 5.0 ml of water are added slowly and with vigorous stirring. Crystallization of the hydrated form starts immediately. X-ray powder diffraction of the filtered product at 90% atmospheric humidity reveals an x-ray diagram with reflexes as shown in Table 1.

### EXAMPLE 5

Wheat seeds are sown in the greenhouse in plastic pots comprising 0.5 l of garden soil. After the plants have emerged up to the 2- to 3-leaf stage, the safener of the formula I, prepared in accordance with Example 4, together with the herbicide propynyl (R)-2[4-[(5-chloro-3-fluoro-2-pyridynyl]oxy-phenoxy]propanoate are applied as a tank mix. 20 days post-application, the protective action of the safener is determined in comparison with the plants which have been treated with the herbicide only. The safener used is very effective.

Similar results are also obtained when using another herbicide from the above enumeration

What is claimed is:

1. An agrochemical composition in the form of a suspension concentrate comprising, in addition to further customary formulation auxiliaries, a surface-active compound and a quinoline safener, wherein the quinoline safener is one of the formula I 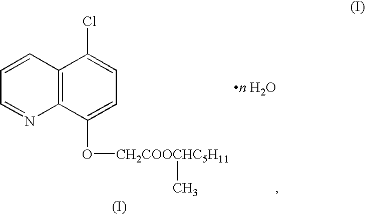
in which n is 2 to 6.

2. A composition according to claim 1, which comprises, as quinoline safener, a compound of the formula I which is characterized by the powder x-ray reflexes shown in Table 1.

3. A composition according to claim 1, which comprises, as surface-active compounds, anionic, cationic and/or nonionic surfactants.

4. A composition according to claim 3, which comprises, as surface-active compound, partially alkylated polyvinylpyrrolidones, polyacrylates with PO side chains, sulphonated naphthalene/formaldehyde condensates, ethoxylated polyarylphenol sulphates, diglycol cyclohexyldimethanol isophthalate sulphoisophthalate mixed polyesters, polyacrylates with basic adhesive groups, unmodified or polyether-modified, surface-active linear polyesters, di- and tristyrylphenol ethoxylates, di- and tristyrylphenol phosphates, di- and tristyrylphenol sulphates, and mixtures of these.

5. A composition according to claim 1, which comprises a herbicide.

6. A method of controlling undesired plant growth, wherein a composition according to claim 1 is applied to the crop plants or their environment after dilution with customary diluents, independently of the point in time of application of the herbicide.

7. A method according to claim 6, wherein the diluents comprise adjuvants.

8. A method of controlling undesired plant growth, wherein a herbicidally active amount of a composition according to claim 5 is applied to the crop plants or their environment after dilution with customary diluents.

9. A method according to claim 8, wherein the diluents comprise adjuvants.

10. A compound of the formula 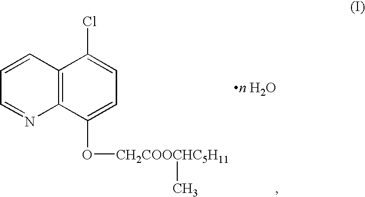
in which n is 2 to 6.
